(19) United States
(12) Patent Application Publication
(10) Pub. No.: US 2020/0060325 A1
(43) Pub. Date: Feb. 27, 2020

(54) Vacuum packaging equipment for breaking nuts

(71) Applicant: Liping Ye, Fuqing City (CN)

(72) Inventor: Liping Ye, Fuqing City (CN)

(21) Appl. No.: 16/671,192

(22) Filed: Nov. 1, 2019

(30) Foreign Application Priority Data
Jul. 9, 2019 (CN) 2019106165369

(51) Int. Cl. A23N 5/00; B65B 31/04; B65B 57/06; B65B 57/12; B65B 35/32; B65B 41/10; B65B 51/00

(52) U.S. Cl. CPC A23N 5/00; B65B 31/042; B65B 31/048; B65B 57/06; B65D 81/2023; B65B 35/32; B65B 41/10; B65B 51/00; B65B 57/12

(57) ABSTRACT

The invention discloses a nut breaking vacuum packaging device, which includes a machine body, the machine body includes a round cavity, the back end wall of the round cavity rotates and is provided with a first rotating shaft extending back and forth, the first rotating shaft is fixedly provided with a blade. The energy utilization rate is high. After the shelling is completed, the peeled nut kernel is automatically put into the plastic basket according to the fixed weight by the equipment. The automatic flow in process of the plastic basket has perfect function and sensitive response. In the process of packaging and sealing, the equipment is automatic at the same time The process of air extraction and sealing is of high efficiency and high degree of integration. The packed plastic basket is sent out. The equipment has a high energy utilization rate, and the operation is simple and quick.

### CROSS-REFERENCES TO RELATED APPLICATIONS

The present application claims priority from Chinese application No. 2019106370611 filed on Jul. 15, 2019 which is hereby incorporated by reference in its entirety.

### TECHNICAL FIELD

The present invention relates to the field of fast food packaging, in particular to a vacuum packaging equipment for breaking nuts.

### BACKGROUND OF THE INVENTION

As we all know, nut food has high nutrition, delicious taste and great benefits to human body. With the continuous improvement of living standards, people's demand for nut food is increasing day by day. However, the shelling and packaging of nut food has become a recognized problem. General nut food manufacturers are carrying out shelling and packaging separately, with efficiency Low quality and long working cycle will affect the quality of nuts. At the same time, the sheller on the market is unable to separate the nut kernel and waste shell that have been shelled, and the general nut packing machine only has the function of sealing. In this way, the packed nuts can not be stored for a long time, and will be moldy and rotten, because the air inside is not convenient for transportation and storage. Therefore, it is necessary to A new type of nut breaking vacuum packaging equipment is designed to solve the above problems.

### BRIEF SUMMARY OF THE INVENTION

The technical problem to be solved by the invention is to provide a nut breaking vacuum packaging device, which can peel nuts, separate nut kernel and waste shell, and then quickly extract air for packaging. The device is sensitive and has rich functions.

The invention is realized by the following technical scheme.

The invention relates to a nut breaking vacuum packaging device, which comprises a body, which is characterized in that the body comprises a circular cavity;

The back end wall of the circular cavity rotates and is provided with a first rotating shaft extending back and forth, the first rotating shaft is fixedly provided with a blade, the circular cavity is provided with a shelling mechanism which makes the nut collide with the wall body to break the nut through the high-speed rotation of the blade, and the rotation of the first rotating shaft drives the blade to rotate to peel the nut;

The lower part of the circular cavity is provided with a transportation cavity with an opening to the right, the rear wall of the transportation cavity is provided with a transmission cavity, and the transmission cavity and the transportation cavity are provided with a rolling mechanism for transporting food plastic baskets;

The right wall of the circular cavity is provided with a sealing mouth with an opening downward and communicated with the transportation cavity. The sealing mouth is provided with a sealing mechanism to extract air from the food plastic basket and seal it. The first sliding mouth is provided with a first sliding block. The first sliding block is provided with a first sliding slot through the top and bottom. The first sliding slot is provided with a second sliding block, and the second sliding block is fixed with a plastic The bottom wall of the first slide block is provided with a shaft cavity with an opening downward. The shaft cavity is symmetrically rotated back and forth with a second shaft extending left and right. The second shaft is fixedly provided with a sealing clamping claw for sealing the plastic basket;

The rear end wall of the sealing mouth is communicated with a rolling cavity, the rolling cavity is provided with a control mechanism for controlling the up and down sliding of the sealing mechanism, the left end wall of the rolling cavity is provided with a first wind cavity, the rolling cavity and the first wind cavity are rotated with a third rotation axis extending left and right, and the third rotation axis controls the up and down sliding of the first slider through gear engagement.

Further, the shelling mechanism includes the circular cavity with the opening upward, the rear wall of the circular cavity is provided with the driving cavity, the end wall between the driving cavity and the circular cavity is provided with the moving cavity, the top wall of the circular cavity is communicated with the feeding port, the circular cavity is communicated with the waste discharging port with the opening forward, and the circular cavity and the driving cavity are rotated with the front and rear extending the A rotating shaft, the first rotating shaft in the circular cavity is fixedly provided with the blade, and the blade is provided with circular holes arranged and distributed.

Further, the front wall of the moving cavity is provided with a second sliding groove which penetrates forward and backward, the second sliding groove is provided with a vulnerability plate, the vulnerability plate is provided with a first through hole which penetrates up and down, the second sliding groove is provided with a first connecting rod which is fixedly connected with the rear end face of the vulnerability plate, the first connecting rod and the rear wall of the moving cavity are fixedly provided with a first spring, and the movement The cavity and the transmission cavity are rotationally provided with a fourth rotating shaft extending back and forth, the fourth rotating shaft of the transmission cavity is fixedly provided with a cone block, and the slope of the cone block is in close contact with the first connecting rod.

Further, the shell stripping mechanism comprises a waiting cavity communicated between the circular cavity and the transportation cavity, wherein the waiting cavity rotates with a fifth rotating shaft extending forward and backward, on which a blocking plate capable of blocking the waiting cavity is fixed, the left end wall of the waiting cavity is provided with a first sliding cavity with an opening upward, and the first sliding cavity is sliding with the bottom of the blocking plate A top block in face contact is provided with a second through hole which penetrates left and right in the top block, a first electric coupling switch is fixedly arranged on the bottom end wall of the first sliding chamber, a second spring is fixedly connected between the first electric coupling switch and the top block, an inclined sliding chamber is arranged in the left end wall of the first sliding chamber, and an arc clamping groove is communicated between the inclined sliding chamber and the first sliding chamber A rolling ball extending into the second through hole is arranged in the shaped clamping groove, the bottom end wall of the waiting cavity is provided with a second sliding cavity communicated with the transportation cavity, the left end wall of the second sliding cavity is provided with a third sliding groove with an opening upward, the third sliding groove is provided with a first magnet extending into the second sliding cavity, and the bottom end wall of the third sliding groove is fixedly provided with an electric switch connected with the first electric switch Connect the first electromagnet.

Further, the control mechanism comprises a second wind cavity arranged on the rear wall of the transmission cavity, the right end wall of the second wind cavity is fixedly provided with a wind motor, the wind motor is rotationally connected with a sixth rotation axis, the sixth rotation axis is fixedly provided with a first leaf fan, the second wind cavity and the circular cavity are communicated with each other with a first ventilation pipe, and the first wind cavity and the second wind cavity are connected with each other A second ventilation pipe is communicated between the two wind cavities, the rolling cavity and the first wind cavity are rotationally provided with the third rotating shaft extending left and right, the third rotating shaft of the first wind cavity is fixedly provided with a second leaf fan, the third rotating shaft of the rolling cavity is fixedly provided with a gear, the rear end face of the first slider is fixedly provided with a first rack, and the gear The wheel is meshed with the first rack, the top wall of the second ventilation pipe is provided with a fourth sliding groove with an opening downward, the fourth sliding groove is provided with a second magnet which can contact with the bottom surface of the second ventilation pipe, the top wall of the fourth sliding groove is fixed with a second electromagnet, and the rear wall of the transportation cavity under the sealing mouth is fixed with an inductor, the inductor and the The second electromagnet is electrically connected.

Further, the clamping mechanism includes the sealing mouth, the top wall of the sealing mouth is fixedly provided with an air pump, the air pump and the suction needle are communicated with each other with a soft rubber tube, the first slide block and the top wall of the sealing mouth are fixedly connected with a third spring, the top wall of the second slide block is provided with a C-shaped opening forward of the beginning, and the outer surface of the second slide block is provided with a front and back A symmetrical second rack is provided with the second shaft extending symmetrically to the left and right in the rotating shaft cavity, the second shaft is fixed with the sealing clamping claw, the sealing clamping claw is fixed with the sector teeth, the second rack is meshed with the sector teeth to control the rotation of the sealing clamping claw, the front wall of the sealing mouth is communicated with the fifth sliding groove, and the The upper side of the fifth chute is provided with a sixth chute with an opening backward, the fifth chute is provided with a first inclined slider, the sixth chute is provided with a third slider, the front end of the third slider is fixed with a piston, the rear end wall of the third slider is fixed with a second inclined slider, the fifth chute and the sixth chute are connected with a hydraulic pipeline through transmission, and the movable The plug slides in the upper side of the hydraulic pipe, and a fourth spring is fixedly connected between the first inclined sliding block and the front wall of the fifth sliding groove.

Further, the rolling mechanism includes the drive cavity, the rear end wall of the drive cavity is fixed with a motor, the motor and the drive cavity and the transport cavity are rotated with a first belt shaft extending forward and backward, the first belt pulley is fixed on the first belt shaft of the transport cavity, the second belt shaft extending forward and backward is rotated at the opening of the right end wall of the transport cavity The second belt pulley is fixed on the second belt shaft, the transportation cavity is rotated with a third belt shaft extending forward and backward, the third belt shaft is fixed with a third belt pulley, the first belt pulley, the second belt pulley and the third belt pulley are driven with a first belt, the first belt shaft in the transmission cavity is fixed with a fourth belt pulley, and the fourth belt in the transmission cavity A fifth belt pulley is fixed on the rotating shaft, a sixth belt pulley is fixed on the first rotating shaft in the transmission cavity, and a second belt is rotated on the fourth belt pulley, the fifth belt pulley and the sixth belt pulley.

Beneficial effect of the invention: the device of the invention peels and separates nut nuts with shells and then carries out air extraction packaging. In the process of shelling, the nut nuts peeled and the waste shells are separated at the same time. The utilization rate of kinetic energy is high. The device discharges the waste materials in a unified way. After shelling, the device automatically loads the peeled nuts into a plastic basket according to the fixed weight, which is convenient for transportation and Processing, the automatic inflow function of the plastic basket is perfect, and the response is sensitive. In the process of packaging and sealing, the equipment automatically extracts air and seals at the same time. This process is highly efficient and has a high degree of integration. Then the packaged plastic basket is sent out, the equipment has a high energy utilization rate, and the simple operation process is safe and fast.

### BRIEF DESCRIPTION OF THE DRAWINGS

In order to explain the embodiments of the invention or the technical solutions in the prior art more clearly, the following will give a brief introduction to the drawings needed in the embodiments or the prior art description. It is obvious that the drawings in the following description are only some embodiments of the invention. For ordinary technicians in the skill field, they can also use these drawings without paying creative labor Other figures are obtained from the figures.

FIG. 1 is the overall schematic structural diagram of the invention;

FIG. 2 is the structural diagram of “A-A” direction in FIG. 1;

FIG. 3 is the structural diagram of “C-C” direction in FIG. 1;

FIG. 4 is an enlarged diagram of the “D” structure of FIG. 1;

FIG. 5 is an enlarged diagram of the “E” structure of FIG. 2;

FIG. 6 is the structural diagram of “B-B” direction in FIG. 1.

### DETAILED DESCRIPTION OF THE INVENTION

The invention relates to an automatic sunshade used in public places, which is mainly used in the field of automatic sunshade. The invention will be further described in combination with the drawings of the invention:

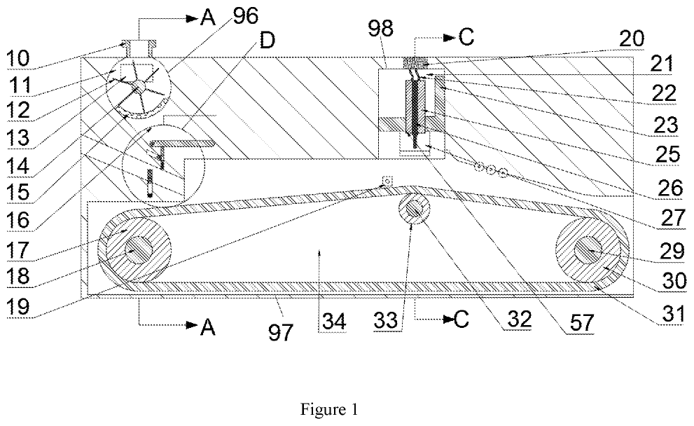

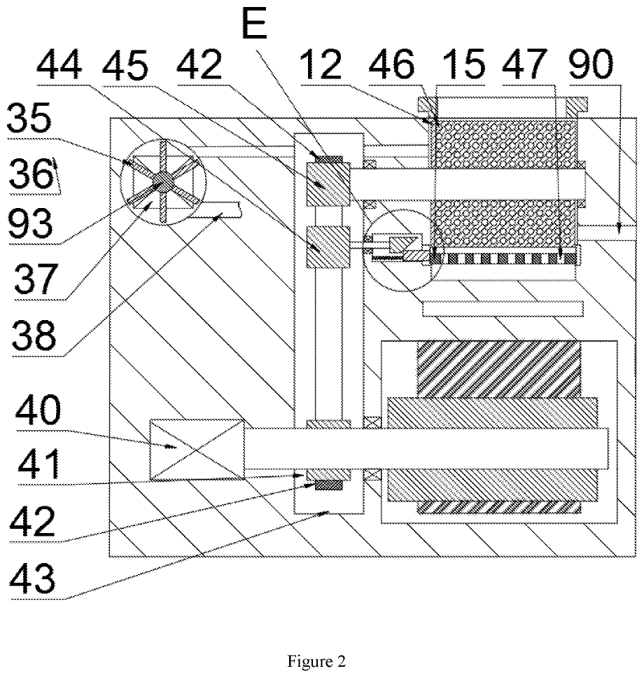

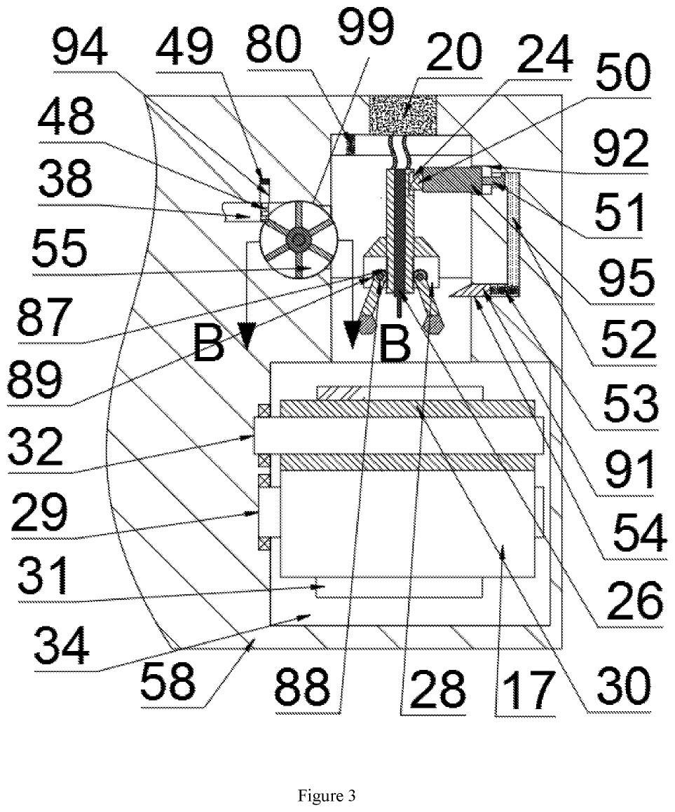

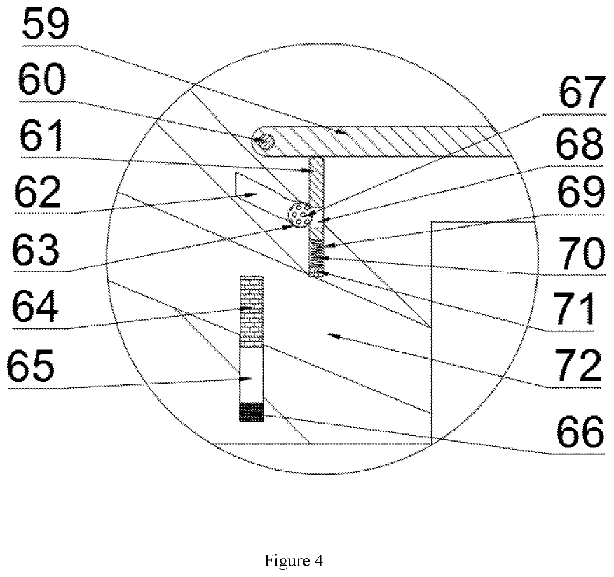

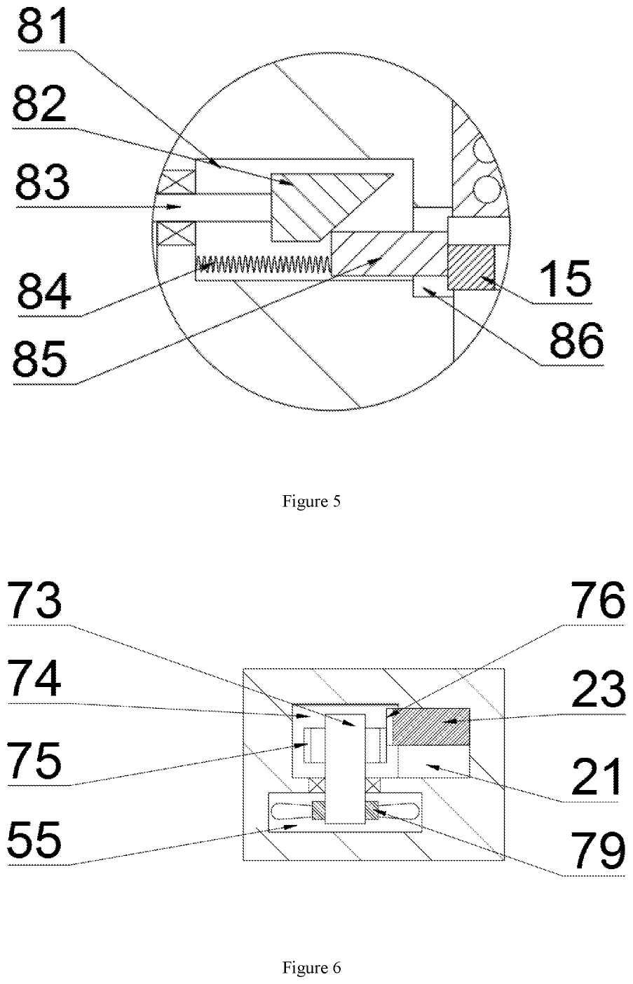

A nut breaking vacuum packaging device according to FIG. 1-6, including a fuselage 58, which includes a circular cavity 11, wherein the back end wall of the circular cavity 11 rotates and is provided with a first rotating shaft 14 extending back and forth, on which a blade 12 is fixed, and a shell stripping mechanism 96 is arranged in the circular cavity 11 to break nuts by the nuts colliding with the wall body through the high-speed rotation of the blades, and the first rotating shaft 14 rotation drives the blade 12 to rotate to peel the nut;

The lower part of the circular cavity 11 is provided with a transportation cavity 34 with an opening to the right, the rear wall of the transportation cavity is provided with a transmission cavity 43, and the transmission cavity 43 and the transportation cavity 34 are provided with a rolling mechanism 97 for transporting food plastic baskets;

The right wall of the circular cavity 11 is provided with a sealing mouth 21 with an opening downward and communicated with the transportation cavity 34. The sealing mouth 21 is provided with a sealing mechanism 98 for extracting and sealing the air in the food plastic basket. The sealing mouth 21 is sliding with a first slide 23, the first slide 23 is provided with a first slide 57 penetrating up and down, the first slide 57 is sliding with a second slide 25, and the second slide The first slide 23 bottom wall is provided with a rotating shaft cavity 28 with an opening downward, the rotating shaft cavity 28 is provided with a second rotating shaft 88 extending to the left and right, and the second rotating shaft 88 is provided with a sealing clamping claw 27 for sealing the plastic basket;

The rear wall of the sealing cavity 21 is communicated with the rolling cavity 74, the rolling cavity 74 is provided with a control mechanism 99 for controlling the up and down sliding of the sealing mechanism 98, the left end wall of the rolling cavity 74 is provided with a first wind cavity 55, the rolling cavity 74 and the first wind cavity 55 are rotated with a third rotating shaft 73 extending left and right, and the third rotating shaft 73 controls the first sliding block 23 through gear engagement Slide down.

The shelling mechanism 96 includes the circular cavity 11 with an opening upward, the rear wall of the circular cavity 11 is provided with the driving cavity 43, the end wall between the driving cavity 43 and the circular cavity 11 is provided with the moving cavity 81, the top wall of the circular cavity 11 is communicated with the feeding port 10, the circular cavity 11 is communicated with the waste discharging port 90 with the opening forward, the circular cavity 11 is rotated with the driving cavity 43, and is provided with the front and rear extension The first rotating shaft 14 in the circular cavity 11 is fixedly provided with the blade 12, the blade 12 is provided with the circular holes 46 arranged and distributed, the front wall of the moving cavity 81 is provided with the second sliding groove 86 which is penetrated in front and back, the second sliding groove 86 is provided with the vulnerability plate 15, the vulnerability plate 15 is provided with the first through hole 47 which is penetrated in the upper and lower part, and the second sliding groove 86 is sliding in the front A first connecting rod 85 fixedly connected with the rear end face of the leak plate 15 is provided, a first spring 84 is fixedly arranged between the first connecting rod 85 and the rear wall of the moving cavity 81, the moving cavity 81 and the driving cavity 43 are rotationally provided with a fourth rotating shaft 83 extending forward and backward, the fourth rotating shaft 83 in the driving cavity 81 is fixedly provided with a cone block 82, and the slope of the cone block 82 is tightly connected with the first connecting rod 85 Close contact: when the 14 rotates, the first rotating shaft 14 drives the blade 12 to rotate, the fourth rotating shaft 83 drives the cone block 82 to rotate, the cone block 80 pushes the first connecting rod 85 to slide forward and backward, and the first connecting rod 85 drives the vulnerability plate 15 to slide forward and backward.

The shelling mechanism 96 includes a waiting cavity 16 communicated between the circular cavity 11 and the transportation cavity 34. The waiting cavity 16 is rotationally provided with a fifth rotating shaft 60 extending forward and backward. The fifth rotating shaft 60 is fixedly provided with a blocking plate 59 that can block the waiting cavity 16. The left end wall of the waiting cavity 16 is provided with a first sliding cavity 69 with an opening upward, and the first sliding cavity 69 is slidably provided with a blocking plate and a blocking plate The top block 61 contacted with the bottom surface of the baffle 59 is provided with a second through hole 68 penetrating left and right, the bottom end wall of the first sliding chamber 69 is fixedly provided with a first electric coupling switch 71, the first electric coupling switch 71 and the top block 61 are fixedly connected with a second spring 70, the left end wall of the first sliding chamber 69 is provided with an inclined sliding chamber 62, and the inclined sliding chamber 62 and the first sliding chamber 69 are fixedly connected with each other The arc-shaped clamping groove 63 is communicated with a rolling ball 67 extending into the second through hole 68, the bottom end wall of the waiting cavity 16 is provided with a second sliding cavity 72 communicated with the transport cavity 34, the left end wall of the second sliding cavity 72 is provided with a third sliding groove 65 with an opening upward, the third sliding groove 65 is provided with a first magnet 64 extending into the second sliding cavity 72, and the third sliding groove 65 is provided with a first magnet 64 extending into the second sliding cavity 72 The bottom end wall of the three chute 65 is fixedly provided with a first electromagnet 66 which is electrically connected with the first electrically connected switch 71. When the food is stacked to a certain weight, the top block 61 increases the pressure on the 68, and the pressure on the 68 top surface of the roller ball 67 is too high to make the roller ball 67 slide into the inclined sliding chamber 62 from the arc-shaped clamping groove 63. After the roller ball 67 slides, it will no longer restrict the top block 61 to slide downward After the top block 61 glides down, it will not push the blocking plate 59, the blocking plate 59 will rotate around the fifth rotating shaft 60 to drop the nut nut blocked by the blocking plate 59, the top block 61 will descend and squeeze the first electric coupling switch 71, the first electric coupling switch 71 will cut off the first electromagnet 66, the first electromagnet 66 will stop repelling the first magnet 64, and the first magnet 64 will slide down, At this time, the plastic basket blocked by the first magnet 64 in the second sliding chamber 72 is opened, and a plastic basket enters the transportation chamber 34. The upper half of the plastic basket is plastic film, and the lower half of the plastic basket is a cardboard box.

The control mechanism 99 includes a second wind cavity 36 arranged on the rear wall of the transmission cavity 43, a wind motor 37 fixed on the right end wall of the second wind cavity 36, a sixth rotating shaft 93 rotationally connected with the wind motor 37, a first leaf fan 35 fixed on the sixth rotating shaft 93, a first ventilation pipe 13 connected between the second wind cavity 36 and the circular cavity 11, and a first wind cavity 55 A second ventilation pipe 38 is communicated with the second wind chamber 36, the third rotating shaft 73 extending left and right is rotating between the rolling chamber 74 and the first wind chamber 55, the third rotating shaft 73 in the first wind chamber 55 is fixedly provided with a second leaf fan 79, the third rotating shaft 73 in the rolling chamber 74 is fixedly provided with a gear 75, and the rear end surface of the first slide 23 is fixedly provided with a gear 75 The first rack 76 is fixedly arranged, the gear 75 is meshed with the first rack 76, the top wall of the second ventilation pipe 38 is provided with a fourth sliding groove 94 with an opening downward, the fourth sliding groove 94 is provided with a second magnet 48 which can contact with the bottom surface of the second ventilation pipe 38, the top wall of the fourth sliding groove 94 is fixedly provided with a second electromagnet 49, which is located at the lower side of the sealing mouth 21 and the transportation The rear wall of the cavity 34 is fixedly provided with a sensor 19, which is electrically connected with the second electromagnet 49. When the wind motor 37 is turned on, the wind motor 37 drives the sixth rotating shaft 93 to rotate, the sixth rotating shaft 93 drives the first leaf fan 35 to rotate, and the first leaf fan 35 rotates to generate wind power. The main part of the wind power enters the circular cavity 11 through the first ventilation pipe 13 The other part enters the first wind chamber 55 through the second ventilation duct 38. When the sensor 19 senses that there is a plastic basket, the second electromagnet 49 is electrified and opened to generate a magnetic force. The second magnet 48 rises and the wind enters the first wind chamber 55. The wind entering the first wind chamber 55 drives the second leaf fan 79 to rotate, and the second leaf fan 79 The third shaft 73 drives the gear 75 to drive, and the gear 75 drives the first slide 23 to slide downward through the first rack 76.

The clamping mechanism 91 includes the sealing mouth 21, the top wall of the sealing mouth 21 is internally fixed with an air pump 20, the air pump 20 is communicated with the suction needle 26 with a soft rubber tube 22, the first slide 23 is fixedly connected with the top wall of the sealing mouth 21 with a third spring 80, the top wall of the second slide 25 is provided with a C-shaped opening 24 with a front end, and the outer surface of the second slide 25 The second rack 87 is provided with a front and back symmetrical second rack 87, the second shaft 88 is provided with a front and back symmetrical left and right extended rotating shaft cavity 28, the second shaft 88 is fixed with the seal clamping claw 27, the seal clamping claw 27 is fixed with a sector tooth 89, the second rack 87 controls the seal clamping claw 27 to rotate by engaging with the sector tooth 89, and the front wall of the seal mouth 21 is internally connected The fifth chute 54 is provided with a sixth chute 92 with an opening to the rear on the upper side of the fifth chute 54, a first ramp slider 91 is arranged in the fifth chute 54, a third slider 95 is arranged in the sixth chute 92, a piston 51 is arranged at the front end of the third slider 95, a second ramp slider 50 is arranged at the rear wall of the third slider 95, the fifth chute 54 and the The sixth slide groove 92 is connected with a hydraulic pipe 52, the piston 51 slides in the upper side of the hydraulic pipe 52, the first inclined slide 91 and the front wall of the fifth slide groove 54 are fixedly connected with a fourth spring 53, when the first slide 23 slides downward, the first slide 23 drives the second slide 25 to slide downward, and the second slide 25 drives the suction needle 26 Slide downward into the plastic basket, the air pump 20 draws air through the soft rubber tube 22, at this time, the suction needle 26 sucks the air in the plastic basket, when the first slide 23 slides down, it compresses the first inclined slide 91, the first inclined slide 91 slides forward, the first inclined slide 91 drives the piston 51 to move backward through the hydraulic pipe 52, and the piston 51 Driving the third slider 95 to slide backward, the third slider 95 to drive the second inclined slider 50 to move backward and extrude the top wall of the C-shaped opening 24, the second inclined slider 50 contacts the top wall of the C-shaped opening, the second inclined slider 50 extrudes the C-shaped opening 24, the C-shaped opening top wall drives the second slider 25 to move upward, and the second slider 25 slides upward through the C-shaped opening top wall The second rack 87 engages and rotates the sector tooth 89, and the second rack 87 drives the second rotating shaft 88 and the sealing clamping claw 27 to rotate through the sector tooth 89. At this time, the two sector teeth 89 rotate inward to clamp and seal the sealing clamping claw 27. When the sensor 19 fails to sense the plastic basket, the second electromagnet 49 is powered off, and the second magnet 48 is powered by gravity again The second ventilation pipe 38 is blocked, the first sliding block 23 rises by the elastic force of the third spring 80, the first inclined sliding block 91 recovers to the original position because the fourth spring 53 recovers to the original position, the second inclined sliding block 50 recovers to the original position through the hydraulic pipe 52, and the sealing clamping claw is released The sealing clamping claw 27 no longer holds the plastic basket.

The rolling mechanism 97 includes the driving cavity 43, the rear end wall of the driving cavity 43 is fixedly provided with a motor 40, the motor 40 is rotated with the driving cavity 43 and the transportation cavity 34, the first belt shaft 18 extending forward and backward is provided, the first belt shaft 18 in the transportation cavity 34 is fixedly provided with the first belt pulley 17, and the right end wall opening of the transportation cavity 34 is rotated with the second belt shaft 2 extending forward and backward 9. The second belt shaft 29 is fixedly provided with a second belt pulley 30, the transportation cavity 34 is rotated with a third belt shaft 32 extending forward and backward, the third belt shaft 32 is fixedly provided with a third belt pulley 33, the first belt pulley 17, the second belt pulley 30 and the third belt pulley 33 are driven with a first belt 31, the first belt shaft 18 in the transmission cavity 43 is fixedly provided with a fourth belt pulley 41 The fourth shaft 83 in the transmission cavity 43 is fixedly provided with a fifth pulley 44, the first shaft 14 in the transmission cavity 43 is fixedly provided with a sixth pulley 45, the fourth pulley 41, the fifth pulley 44 and the sixth pulley 45 are rotationally provided with a second belt 42, the motor 40 is started, the motor 40 drives the first belt shaft 18 to rotate, and the first leather The belt shaft 18 simultaneously drives the first pulley 17 and the fourth pulley 41 to rotate, the first pulley 17 drives the first belt 31 to rotate, the fourth pulley 41 drives the second belt 42 to rotate, the second belt 42 drives the fifth pulley 44, the sixth pulley 45 to rotate, and the fifth pulley 44 drives the fourth shaft 83 to rotate, The sixth pulley 45 drives the first rotating shaft 14 to rotate, the second pulley 42 drives the fifth pulley 44, and the sixth pulley 45 to rotate. Because the position of the third pulley 33 is higher than the first pulley 17, the first belt 31 first transports the plastic basket up obliquely, and then downward obliquely.

Sequence of mechanical actions of the whole device:

1. Open the motor 40, the motor 40 drives the first belt shaft 18 to rotate, the first belt shaft 18 drives the first belt pulley 17 to rotate, the first belt pulley 17 drives the first belt 31 to rotate, the first belt shaft 18 simultaneously drives the fourth belt pulley 41 to rotate, the fourth belt pulley 41 drives the second belt 42 to rotate, and the second belt 42 drives the second belt 42 to rotate The fifth pulley 44 and the sixth pulley 45 rotate, the fifth pulley 44 drives the fourth shaft 83 to rotate, and the sixth pulley 45 drives the first shaft 14 to rotate;

2. Turn on the wind motor 37, the wind motor 37 drives the sixth rotating shaft 93 to rotate, the sixth rotating shaft 93 drives the first leaf fan 35 to rotate, the first leaf fan 35 to generate wind force, the main part of the wind force enters the circular cavity 11 through the first ventilation pipe 13, the fourth rotating shaft 83 drives the conical block 82 to rotate, and the conical block 80 drives the first connection The rod 85 slides backward, the first spring 84 slides the first connecting rod 85 forward, the first connecting rod 85 slides back and forth, the first connecting rod 85 drives the vulnerability plate 15 to slide back and forth, the fourth rotating shaft 83 drives the cone block 82 to rotate, the cone block 80 pushes the first connecting rod 85 to slide backward, the first spring 84 slides the first connecting rod 85 forward, and the A connecting rod 85 slides back and forth, the first connecting rod 85 drives the vulnerability plate 15 to slide back and forth, and nut nuts slide back and forth into the blocking plate 59 in the waiting chamber 16 because the vulnerability plate 15 slides back and forth;

3. The feeding port 10 is provided with hard nut material, the first rotating shaft 14 drives the blade 12 to rotate, the nut shell is peeled by collision during the rotation, the nut peeled through the shell passes through the circular hole 46, falls onto the loophole plate 15 sliding forward and backward during the rotation, and the first ventilation pipe 13 blows a large amount of wind into the circular cavity 11, because the nut shell is light in weight, the nut shell is The wind force blows out from the waste discharge port 90, the leak plate passes through the first through hole 47, peels the nut nuts through the shell into the waiting cavity 16, and piles on the blocking plate 59. When the food is piled up, the top block 61 is pressed downward to squeeze the ball 67, and the ball 67 cannot move in the arc-shaped groove 63 due to insufficient extrusion pressure, when the food is piled up to a certain weight The top block 61 pushes the ball 6 too much, which causes the ball 67 to slide into the inclined sliding chamber 62 from the arc-shaped clamping groove 63, the top block 61 drops, the block plate 59 rotates, all foods on the block plate 59 can enter the transport chamber 34, the top block 61 drops and touches the first electric coupling switch 71, the first electromagnet 66 is electrified, and the first magnetic field is cancelled The repulsive force of iron 64, the first magnet 64 drops, the second sliding chamber 72 is connected with the transportation chamber 34, enters a plastic basket, and loads the food piled up on the blocking plate 59 into the transportation chamber 34, the first belt 31 drives the plastic basket with nuts to move to the right, the device does not need manual loading, and the integration degree is high;

4. When the plastic basket moves to the right to the induction position of the inductor 19, the second electromagnet 49 opens to generate a magnetic force, the second electromagnet 49 drives the second magnet 48 to slide up, and the wind enters the first wind chamber 55, at this time, the second leaf fan 79 rotates, the second leaf fan 79 drives the third rotating shaft 73 to rotate, the third rotating shaft 73 drives the gear 75 to drive, and The gear 75 drives the first slide 23 to slide downward through the first rack 76. When the first slide 23 slides downward, the suction needle 26 slides downward. The suction pump 20 draws air through the soft rubber tube 22. The suction needle 26 draws air from the plastic basket, and the C-shaped opening 24 moves downward;

5. When the first slide 23 drops, the first inclined slide 91 is squeezed, the first inclined slide 91 slides forward, the piston 51 is driven to move backward by the hydraulic pipe 52, the piston 51 is driven to slide backward by the third slide 95, the third slide 95 is driven to move backward by the second inclined slide 50, and the second inclined slide 50 compresses the upper end wall of the C-shaped opening 24, At this time, the second slide 25 moves upward relative to the first slide 23, the second slide 25 moves upward to drive the second rack 87 to slide upward relative to the sector teeth 89, the second rack 87 drives the sector teeth 89 to rotate, the sector teeth 89 drives the sealing clamping claw 27 to rotate, the two sealing clamping claws 27 deflect inward to clamp the plastic basket for sealing, and the second slide 25 moves upward to drive the second rack 87 to slide upward relative to the sector teeth 89 The two slide blocks 25 drive the suction needle 26 to draw out from the plastic basket;

6. Then when the plastic basket moves over the sensor 19, the sensor returns to its initial state, the second electromagnet 49 closes, the second magnet 48 drops, and continues to block the second ventilation pipe 38, the first slide 23 loses the power source of downward sliding, and the third spring 80 slides the first slide 23 back to its initial position through elastic force, when the first slide 23 after returning to the initial position, the two sealing claws 27 rotate reversely and no longer clamp the plastic basket, and the plastic basket falls on the first belt 31 again under the action of gravity, and then the first belt 31 continues to transport the plastic basket that has been pumped and sealed to the right out of the device, which automatically pumps and seals the plastic basket, with high degree of automation, tight transmission and cooperation of various mechanisms, and high kinetic energy High utilization rate.

1. An vacuum packaging equipment for breaking nuts, comprising a fuselage, which is characterized in that: the fuselage includes a circular cavity;
the back end wall of the circular cavity rotates and is provided with a first rotating shaft extending back and forth, the first rotating shaft is fixedly provided with a blade, the circular cavity is provided with a shelling mechanism which makes the nut collide with the wall body to break the nut through the high-speed rotation of the blade, and the rotation of the first rotating shaft drives the blade to rotate to peel the nut;
the lower part of the circular cavity is provided with a transportation cavity with an opening to the right, the rear wall of the transportation cavity is provided with a transmission cavity, and the transmission cavity and the transportation cavity are provided with a rolling mechanism for transporting food plastic baskets;
the right wall of the circular cavity is provided with a sealing mouth with an opening downward and communicated with the transportation cavity. The sealing mouth is provided with a sealing mechanism to extract air from the food plastic basket and seal it. The first sliding mouth is provided with a first sliding block. The first sliding block is provided with a first sliding slot through the top and bottom. The first sliding slot is provided with a second sliding block, and the second sliding block is fixed with a plastic The bottom wall of the first slide block is provided with a shaft cavity with an opening downward. The shaft cavity is symmetrically rotated back and forth with a second shaft extending left and right. The second shaft is fixedly provided with a sealing clamping claw for sealing the plastic basket;
the rear end wall of the sealing mouth is communicated with a rolling cavity, the rolling cavity is provided with a control mechanism for controlling the up and down sliding of the sealing mechanism, the left end wall of the rolling cavity is provided with a first wind cavity, the rolling cavity and the first wind cavity are rotated with a third rotation axis extending left and right, and the third rotation axis controls the up and down sliding of the first slider through gear engagement.

2. The vacuum packaging equipment for breaking nuts as defined in claim 1, wherein The shelling mechanism includes the circular cavity with an opening upward, the rear wall of the circular cavity is provided with the driving cavity, the end wall between the driving cavity and the circular cavity is provided with a moving cavity, the top wall of the circular cavity is communicated with a feeding port, the circular cavity is communicated with a waste discharging port with an opening forward, the circular cavity and the driving cavity are rotated with the first rotating shaft extending forward and backward, and The first rotating shaft in the circular cavity is fixedly provided with the blade, and the blade is provided with the circular holes arranged and distributed.

3. The vacuum packaging equipment for breaking nuts as defined in claim 1, wherein the front wall of the moving cavity is provided with a second sliding groove which penetrates forward and backward, the second sliding groove is provided with a leak plate which is provided with a first through hole which penetrates up and down, the second sliding groove is provided with a first connecting rod which is fixedly connected with the rear end face of the leak plate, the first connecting rod and the rear wall of the moving cavity are fixedly provided with a first spring, the moving cavity and the transmission The moving cavity rotates with a fourth rotating shaft extending forward and backward, and the fourth rotating shaft in the driving cavity is fixedly provided with a cone block, and the slope of the cone block is in close contact with the first connecting rod.

4. The vacuum packaging equipment for breaking nuts as defined in claim 1, wherein the shell stripping mechanism includes a waiting cavity communicated between the circular cavity and the transportation cavity, the waiting cavity is rotated with a fifth rotating shaft extending forward and backward, the fifth rotating shaft is fixed with a blocking plate which can block the waiting cavity, the left end wall of the waiting cavity is provided with a first sliding cavity with an opening upward, and the first sliding cavity is sliding with a top contacting with the bottom surface of the blocking plate The first sliding chamber bottom end wall is fixedly provided with a first electric coupling switch, the first electric coupling switch and the top block are fixedly connected with a second spring, the left end wall of the first sliding chamber is fixedly provided with an inclined sliding chamber, the inclined sliding chamber and the first sliding chamber are communicated with an arc-shaped clamping groove, and the arc-shaped clamping groove is arranged in the arc-shaped clamping groove There is a rolling ball extending into the second through hole, the bottom end wall of the waiting chamber is provided with a second sliding chamber communicated with the transportation chamber, the left end wall of the second sliding chamber is provided with a third sliding groove with an opening upward, the third sliding groove is provided with a first magnet extending into the second sliding chamber, and the bottom end wall of the third sliding groove is fixed with a first electric connection with the first electric connection switch Magnet.

5. The vacuum packaging equipment for breaking nuts as defined in claim 1, wherein T The control mechanism comprises a second wind cavity arranged on the rear wall of the transmission cavity, a wind motor is fixed on the right end wall of the second wind cavity, the wind motor is rotationally connected with a sixth rotating shaft, a first leaf fan is fixed on the sixth rotating shaft, a first ventilation pipe is communicated between the second wind cavity and the circular cavity, and the first wind cavity is connected with the second wind cavity. A second ventilation pipe is communicated with each other, the rolling cavity and the first wind cavity are rotationally provided with the third rotating shaft extending left and right, the third rotating shaft of the first wind cavity is fixedly provided with a second leaf fan, the third rotating shaft of the rolling cavity is fixedly provided with a gear, the rear end face of the first slide block is fixedly provided with a first rack, and the gear and the third rotating shaft are fixedly provided with a gear A rack is engaged, a fourth chute with an opening downward is arranged in the top wall of the second ventilation duct, a second magnet which can contact with the bottom surface of the second ventilation duct is arranged in the sliding of the fourth chute, the top wall of the fourth chute is fixedly provided with a second electromagnet, the rear wall of the transportation chamber under the sealing chamber is fixedly provided with an inductor, and the inductor and the second electromagnet are arranged Ferroelectrics.

6. The vacuum packaging equipment for breaking nuts as defined in claim 1, wherein The clamping mechanism includes the sealing mouth, the top wall of the sealing mouth is fixedly provided with an air pump, the air pump and the suction needle are communicated with each other with a soft rubber tube, the first slide block and the top wall of the sealing mouth are fixedly connected with a third spring, the top wall of the second slide block is provided with a C-shaped opening forward of the beginning, and the outer surface of the second slide block is provided with a second symmetrical front and back The second shaft is fixedly provided with the sealing clamping claw, the sealing clamping claw is fixedly provided with the sector teeth, the second rack controls the rotation of the sealing clamping claw by engaging with the sector teeth, the front wall of the sealing mouth is communicated with the fifth sliding groove, and the fifth sliding groove is connected with the front wall of the sealing mouth the side is provided with a sixth sliding groove with an opening backward, the fifth sliding groove is provided with a first inclined sliding block, the sixth sliding groove is provided with a third sliding block, the front end of the third sliding block is fixed with a piston, the rear end wall of the third sliding block is fixed with a second inclined sliding block, the fifth sliding groove and the sixth sliding groove are connected with a hydraulic pipeline, and the piston slides in the A fourth spring is fixedly connected between the first inclined slide and the front wall of the fifth chute in the upper side of the hydraulic pipeline.

7. The vacuum packaging equipment for breaking nuts as defined in claim 1, wherein the rolling mechanism includes the transmission cavity, the rear end wall of the transmission cavity is fixed with a motor, the motor and the transmission cavity and the transportation cavity are rotated with a first belt shaft extending forward and backward, the first belt shaft of the transportation cavity is fixed with a first belt pulley, the right end wall opening of the transportation cavity is rotated with a second belt shaft extending forward and backward, and the second belt shaft A second belt pulley is fixedly arranged on the upper part, a third belt shaft extending forward and backward is fixedly arranged on the transportation cavity, a first belt pulley is fixedly arranged on the third belt shaft, the first belt pulley, the second belt pulley and the third belt pulley are driven, a fourth belt pulley is fixedly arranged on the first belt shaft in the transmission cavity, and the fourth shaft in the transmission cavity is fixedly arranged A fifth belt pulley is provided, a sixth belt pulley is fixed on the first shaft in the transmission cavity, and a second belt is rotated on the fourth belt pulley, the fifth belt pulley and the sixth belt pulley.
